(19) United States
(12) Patent Application Publication
(10) Pub. No.: US 2006/0255930 A1
(43) Pub. Date: Nov. 16, 2006

(54) Power line communications system and method

(76) Inventor: William H. Berkman, New York, NY (US)

Correspondence Address: MANELLI DENISON & SELTER, 2000 M STREET NW SUITE 700, WASHINGTON, DC, 20036-3307, US

(21) Appl. No.: 11/127,102

(22) Filed: May 12, 2005

(51) Int. Cl. G08B 1/08

(52) U.S. Cl. 340/533; 340/538.11

(57) ABSTRACT

A power line communications that includes a communications device having a first port and a second port is provided. The first port may include a first modem and be communicatively coupled to a power line such as a medium voltage power line. The second port may include a second modem and be communicatively coupled to the first end of a non-power line medium, such as a coaxial cable. The system may include an interface device that couples the second end of the coaxial cable to the internal power line network of the customer premises to provide communications to the user devices coupled to the internal power line network.

### FIELD OF THE INVENTION

The present invention generally relates to data communications over a power distribution system and more particularly, to a system and method that employs power lines and non-power line mediums to provide communications to one or more user devices.

### BACKGROUND OF THE INVENTION

Well-established power distribution systems exist throughout most of the United States, and other countries, which provide power to customers via power lines. With some modification, the infrastructure of the existing power distribution systems can be used to provide data communication in addition to power delivery, thereby forming a power line communications system (PLCS). In other words, existing power lines that already have been run to many homes and offices, can be used to carry data signals to and from the homes and offices. These data signals are communicated on and off the power lines at various points in the power line communication system, such as, for example, near homes, offices, Internet service providers, and the like.

Power system transformers are one obstacle to using power distribution lines for data communications. Transformers act as a low-pass filter, passing the low frequency signals (e.g., the 50 or 60 Hz) power signals and impeding the high frequency signals (e.g., frequencies typically used for data communication). As such, power line communication systems face the challenge of communicating the data signals around, or through, the distribution transformers. In addition, low voltage power lines that extend from the distribution transformer to the customer premises may also provide difficulties for high speed communications due to noise, a wide range of impedances, and reflections.

Thus, there is a need for a power line communications system that can overcome these obstacles and reliably service customers. These and other advantages may be provided by various embodiments of the present invention.

### SUMMARY OF THE INVENTION

The present invention provides a PLCS that includes a communications device having a first port and a second port. The first port may include a first modem and be communicatively coupled to a power line such as a medium voltage power line. The second port may include a second modem and be communicatively coupled to the first end of a non-power line medium, such as a coaxial cable. The system may include an interface device that couples the second end of the non-power line medium to the internal power line network of the customer premises to provide communications to the user devices coupled to the internal power line network.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of an exemplary power distribution system with which the present invention may be employed;

FIG. 2 is a diagram of an example embodiment of a power line communications system of the present invention;

FIG. 3 is block diagram of an example embodiment of a power line/coaxial cable coupler for use in an example embodiment of the present invention; and

FIG. 4 is a block diagram of a communications device, in accordance with an embodiment of the present invention;

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, PLCSs, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, PLCSs, operating systems, development interfaces, and hardware are omitted so as not to obscure the description of the present invention.

System Architecture and General Design Concepts

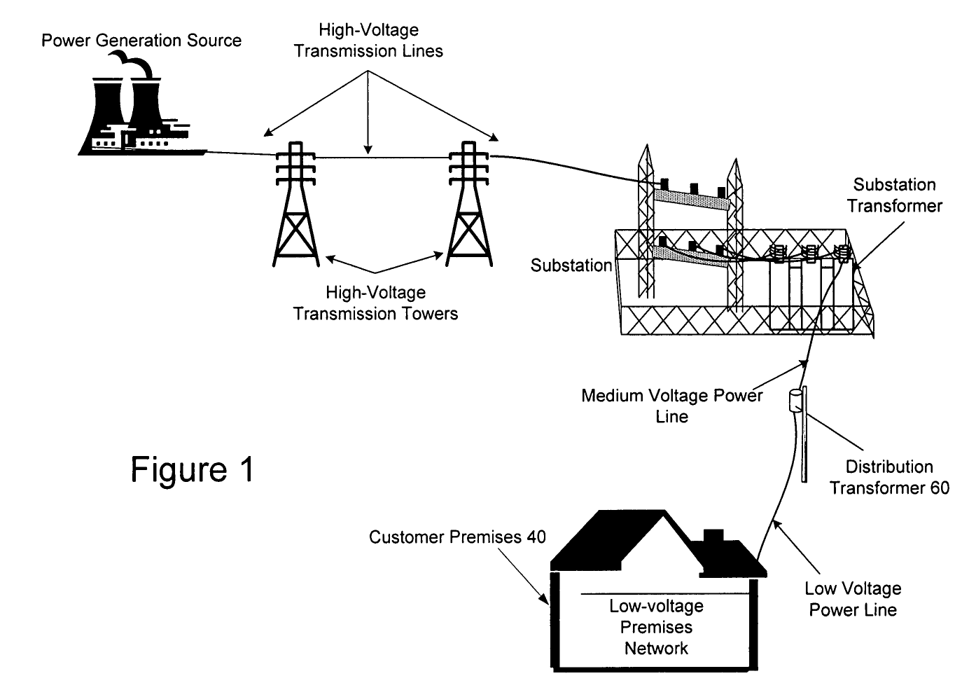

As shown in FIG. 1, power distribution systems typically include components for power generation, power transmission, and power delivery. A transmission substation typically is used to increase the voltage from the power generation source to high voltage (HV) levels for long distance transmission on HV transmission lines to a substation. Typical voltages found on HV transmission lines range from 69 kilovolts (kV) to in excess of 800 kV.

In addition to HV transmission lines, power distribution systems include MV power lines and LV power lines. As discussed, MV typically ranges from about 1000 V to about 100 kV and LV typically ranges from about 100 V to about 1000 V. Transformers are used to convert between the respective voltage portions, e.g., between the HV section and the MV section and between the MV section and the LV section. Transformers have a primary side for connection to a first voltage (e.g., the MV section) and a secondary side for outputting another (usually lower) voltage (e.g., the LV section). Such transformers are often referred to as distribution transformers or a step down transformers, because they “step down” the voltage to some lower voltage. Transformers, therefore, provide voltage conversion for the power distribution system. Thus, power is carried from substation transformer to a distribution transformer over one or more MV power lines. Power is carried from the distribution transformer to the customer premises via one or more LV power lines.

In addition, a distribution transformer may function to distribute one, two, three, or more phase voltages to the customer premises, depending upon the demands of the user. In the United States, for example, these local distribution transformers typically feed anywhere from one to ten homes, depending upon the concentration of the customer premises in a particular area. Distribution transformers may be pole-top transformers located on a utility pole, pad-mounted transformers located on the ground, or transformers located under ground level.

The communication system of the present invention may form part of a PLCS to communicate signals between a power line, such as the medium voltage power line or a neutral conductor, and devices at the customer premises.

Power Line Communication System

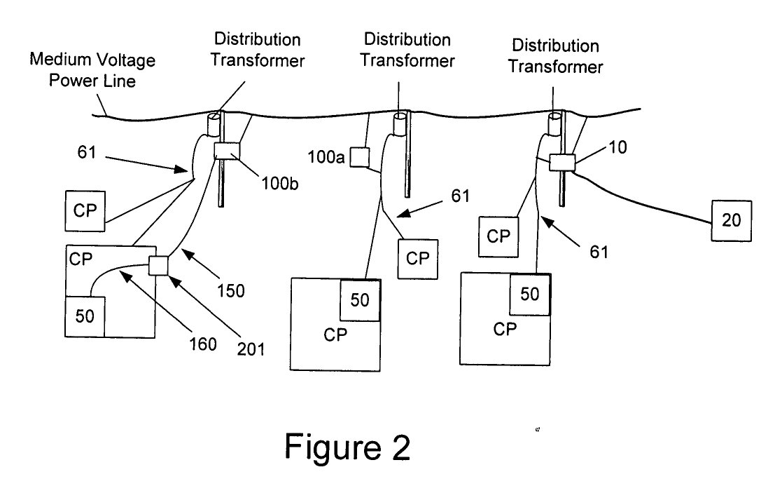

An example PLCS is shown in FIG. 2 and includes one or more bypass devices 100. In this example, bypass device (BD) 100a communicates data signals around the distribution transformer that would otherwise filter such data signals, preventing them from passing through the transformer or significantly degrading them. Thus, the BD 100 is the gateway between the LV power line subnet (i.e., the devices that are communicatively coupled to the LV power lines) and the MV power line and communicates signals to and from user devices at the customer premises (CP).

In this embodiment, the BD 100 provides communication services for the user device, which may include security management, routing of Internet Protocol (IP) packets, filtering data, access control, service level monitoring, signal processing and modulation/demodulation of signals.

This example portion of a PLCS also includes a backhaul point 10, which may also be an alternate embodiment of the present invention. The backhaul point 10 is an interface and gateway between a portion of a PLCS (e.g., an MV run) and a traditional non-power line telecommunications network. One or more backhaul points (BP) 10 are communicatively coupled to an aggregation point (AP) 20 that in many embodiments may be at (e.g., co-located with), or connected to, the point of presence to the Internet. The BP 10 may be connected to the AP 20 using any available mechanism, including fiber optic conductors, T-carrier, Synchronous Optical Network (SONET), or wireless techniques well known to those skilled in the art. Thus, the BP 10 may include a transceiver suited for communicating through the communication medium.

The PLCS also may include a power line server (PLS) that is a computer system with memory for storing a database of information about the PLCS and includes a network element manager (NEM) that monitors and controls the PLCS. The PLS allows network operations personnel to provision users and network equipment, manage customer data, and monitor system status, performance and usage. The PLS may reside at a remote network operations center (NOC), and/or at a PLCS Point of Presence (POP), to oversee a group of communication devices via the Internet. The PLS may provide an Internet identity to the network devices by assigning the devices (e.g., user devices, BDs 100, (e.g., the LV modems and MV modems of BDs), BPs 10, and AP 20) IP addresses and storing the IP addresses and other device identifying information (e.g., the device's location, address, serial number, etc.) in its memory. In addition, the PLS may approve or deny user devices authorization requests, command status reports, statistics and measurements from the BDs, and BPs, and provide application software upgrades to the communication devices (e.g., BDs, BPs, and other devices). The PLS, by collecting electric power distribution information and interfacing with utilities' back-end computer systems may provide enhanced power distribution services such as automated meter reading, outage detection, restoration detection, load balancing, distribution automation, Volt/volt-Amp Reactance (Volt/VAr) management, and other similar functions. The PLS also may be connected to one or more APs and/or core routers directly or through the Internet and therefore can communicate with any of the BDs, user devices, and BPs through the respective AP and/or core router.

The PLCS may further include indoor low voltage repeaters and outdoor low voltage repeaters. Indoor low voltage repeaters may be plugged into a wall socket inside the customer premises. Outdoor low voltage repeaters may be coupled to the external low voltage power line conductors extending from the transformer and therefore, be located between the customer premises and the BD 100. Both the indoor low voltage repeaters and outdoor low voltage repeaters repeat data on the low voltage power line to extend the communication range of the BD 100 and power line modem.

At the user end of the PLCS of this example system, data flow originates from a user device, which provides the data to a power line modem (PLM) 50, which is well-known in the art. The PLM connects the user device to the internal power line network of the customer premises. Further, multiple PLMs can be plugged into power outlets throughout the customer premises, with each PLM 50 communicating over the internal power line of the customer premises to the BD 100.

The user device connected to the PLM 50 may be any device capable of supplying data for transmission (or for receiving such data) including, but not limited to a computer, a telephone, a telephone answering machine, a fax, a digital cable box (e.g., for processing digital audio and video, which may then be supplied to a conventional television and for transmitting requests for video programming), a video game, a stereo, a videophone, a television (which may be a digital television), a video recording device (which may be a digital video recorder), a home network device, a utility meter, or other device. The PLM 50 transmits the data received from the user device through the LV power lines to a BD 100 and provides data received from the LV power line to the user device. The PLM 50 may also be integrated with the user device, which may be a computer. In addition, the functions of the PLM may be integrated into a smart utility meter such as a gas meter, electric meter, water meter, or other utility meter to thereby provide automated meter reading (AMR).

The BD 100 typically transmits the data to (and receives the data from) the backhaul point 10, which, in turn, transmits the data to (and receives the data from) the AP 20. The AP 20 then transmits the data to (and receives the data from) the appropriate destination (perhaps via a core router), which may be a network destination (such as an Internet address) in which case the packets are transmitted to, and pass through, numerous routers (herein routers are meant to include both network routers and switches) in order to arrive at the desired destination.

FIG. 2 also provides an example embodiment of a system according to the present invention. In this example embodiment, BD 100a and BD 100b are coupled to the MV power line to communicate with backhaul point (BP) 10. In other embodiments, the devices may communicate via a neutral conductor that extends between transformers. In this embodiment, BD 100a is coupled to the LV power line subnet 61 to communicate with the user devices in the customer premises receiving power via the LV subnet 61.

In the present invention, rather than communicating data signals to the PLM 50 and/or user devices via the LV power line, the BD 100 may use another communication medium. For example, the BD may convert the data signals to a format for communication via a telephone line, fiber optic, RF cable, coaxial cable line, or other non-power line medium.

In this example, BD 100b is linked to the customer premises via a coaxial cable 150. The coaxial cable 150 may be connected to the BD 100b on its first end and to the internal low voltage power line network 160 on its second end via a power line/coaxial cable coupler (PLCC) 201 at the customer premises CP. The PLCC 201 may be comprised of a pair of high pass filters that permit the higher frequency data signals to couple between the coaxial cable 150 and the internal power line network 160, but prevent the lower frequency power signals from coupling therebetween.

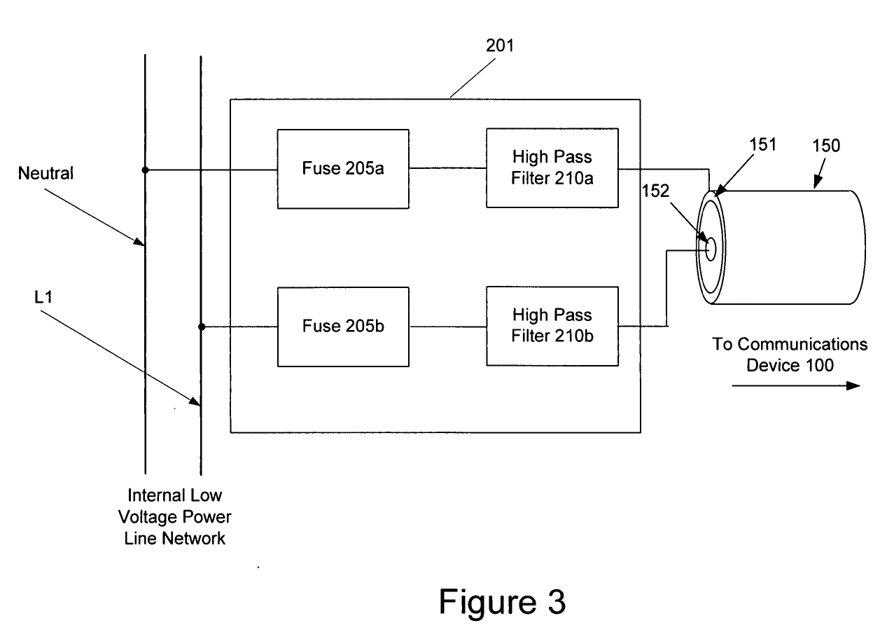

As shown in FIG. 3, the first high pass filter 210a may couple the concentric conductor 151 of the coaxial cable 150 to the neutral LV conductor and the second filter 210b may couple the center conductor 152 of the coaxial cable 150 to the first energized LV conductor L1. The PLCC 201 may make the connection to the internal LV power line network by being plugged into an internal or external electrical outlet or the PLCC may be integrated into an outlet (e.g., and having a coaxial connector exposed externally for connection) or power usage meter, or via any other suitable manner sufficient to allow the signals to propagate to over internal network. The PLCC 201 also may include fuse, such as fuses 210 a and b, and impedance matching and transient suppression circuits. In other words, the connection need not be inside the customer premises. The impedance matching circuit (not shown) may be a balun that may be disposed between the fuses and the LV power line or between the fuses and the filters.

The PLCC 201 alternately may be integrated into the power meter (e.g., which may have the coaxial connector exposed) in which case the first filter of the PLCC 201 may be coupled to the second energized LV conductor (e.g., instead of the neutral) to differentially transmit the data signals on the two LV energized conductors. In this embodiment, the meter may include a coaxial connector, such as mounted to the collar, to permit connection of the coaxial cable to the PLCC integrated into he meter.

In an alternate embodiment, the PLCC 201 may include a first modem and a second modem (e.g., a power line modem chip set) communicatively coupled together to regenerate data signals transmitted to and from the customer premises wiring. The first modem may provide communications with the BD 100b and the second modem (e.g., a PLM) may provide communications for the PLMs in the customer premises that are coupled to the internal power line network 160. The communications between the PLCC 201 and the BD 100b may be OFDM (wherein the first modem may be a power line modem chip set) or DOCSIS (wherein the first modem may be a cable modem).

In other embodiments, instead of a coaxial cable link between the BD 100b and the customer premises, the link may be a twisted pair, Ethernet, optical fiber or wireless. In still another embodiment, the BD 100b may not be connected to the internal LV power line network 160 but instead may be connected to a customer premises wireless network (e.g., 802.11), the internal twisted pair telephone network, or the internal coaxial cable network. For example, the BD 100b may communicate via OFDM via the MV power line and via DOCSIS over a coaxial cable 150 to the customer premises and also DOCSIS over the internal coaxial cable network. In this example embodiment, the PLCC 201 may not be necessary or may be replaced with filters and amplifiers that amplify the particular upstream an downstream frequency bands.

The example BD 100b described above operates to bypass a pole-mounted transformer. Other example BDs suitable for use in the present invention may be equally applicable for use in bypassing other types of transformers (such as pad mount or underground). The BD 100 may provide a path for data to bypass the transformer by being coupled to the same MV power line conductor to which the transformer is coupled or to a different MV power line conductor and, in either instance, may be coupled to the same LV power lines to which the bypassed transformer is coupled. In addition, the BDs 100 may or may not be physically coupled to the same power line conductor to which the BP 10 is physically connected. For example, in overhead PLCS, high frequency data signals may cross-couple between the power line conductors.

Alternately, the BD 100 may communicate with the user device via a fiber optic link. In this alternative embodiment, the BD 100 may convert the data signals to light signals for communication over the fiber optic link. In this embodiment, the customer premises may have a fiber optic cable for carrying data signals, rather than using the internal wiring of customer premise.

Hardware

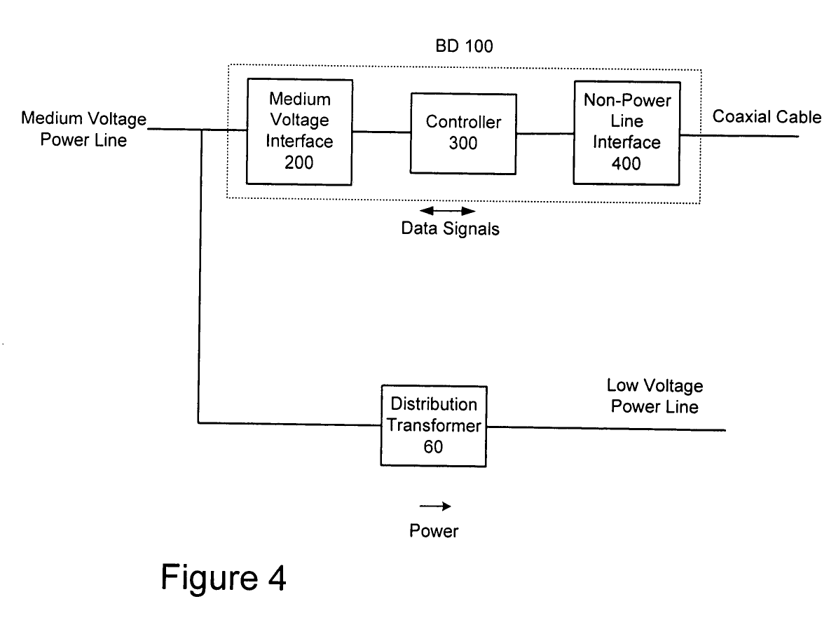

The BD 100b described herein provides bidirectional communications and includes the functional block diagrams shown in FIG. 4. In particular, this embodiment of the BD 100 includes a MV power line interface (MVI) 200, a controller 300, and a non-power line interface (NPI) 400. Both the MVI 200 and NPI 400 may include an adaptive and/or dynamic transmitter to transmit signals at various power levels as determined by the controller 300, which may change the output power in response to a command from the PLS or automatically due to changes in line impedance. The BD 100 is controlled by a programmable processor and associated peripheral circuitry, which form part of the controller 300. The controller 300 includes memory that stores, among other things, routing information and executable program code, which controls the operation of the processor.

Both the MVI 200 and NPI 400 may include a modem and signal conditioning circuitry. Both modems may be OFDM modems, such as a modem employing a HomePlug standard (e.g., 1.0 or AV). However, the NPI 400 of the BD 100b may include a modem such as a PLM, DOCSIS modem, digital subscriber line (DSL) modem, fiber optic transceiver, or wireless transceiver that is suitable for the link. The controller 300 may include a router and may perform routing functions using layer 3 data (e.g., IP addresses), layer 2 data (e.g., MAC addresses), or a combination of layer 2 and layer 3 data (e.g., a combination of MAC and IP addresses). In addition to routing, the controller 300 may perform other functions including controlling the operation of the NPI 400 and MVI 200 functional components and responding to PLS commands and requests. A more complete description of the hardware, firmware, of the BD 100 and its functionality is provided in U.S. patent application Ser. No. 10/315,725 filed Mar. 28, 2005, Attorney Docket No. CRNT-0239, entitled “Power Line Repeater System and Method,” which is hereby incorporated by reference in its entirety. A detailed description of another example PLCS, its components and features is provided in U.S. patent application Ser. No. 10/973,493 filed Oct. 26, 2004, Attorney Docket No. CRNT-0229, entitled “Power Line Communications System and Method of Operating the Same,” which is hereby incorporated by reference in its entirety. The present invention may be used with networks as described in the above patent applications or others. Thus, the invention is not limited to a particular PLCS, PLCS architecture, or topology.

This embodiment of the BD 100 provides bi-directional communications around the distribution transformer to thereby provide a first communications path from the LV power line to the MV power line and a second path from the MV power line to the LV power line. Thus, BD 100 can receive and transmit data to one or more user devices in one or more customer premises via the NPI 400, which may be connected to a plurality customer premises via a plurality of non-power line mediums such as coaxial cables. In addition, the BD 100 may receive and transmit data with other network elements, such as one or more the BPs 10 and other BDs 100, via the MVI 300.

Controller

As discussed, the controller 300 includes the hardware and software for managing communications and control of the BD 100. In this embodiment, the controller 300 may include an IDT 32334 RISC microprocessor for running the embedded application software and also includes flash memory for storing the boot code, device data and configuration information (serial number, MAC addresses, subnet mask, and other information), the application software, routing table, and the statistical and measured data. This memory includes the program code stored therein for operating the processor to perform the routing functions described herein.

This embodiment of the controller also includes random access memory (RAM) for running the application software and temporary storage of data and data packets. This embodiment of the controller 300 may also include an Analog-to-Digital Converter (ADC) for taking various measurements, which may include measuring the temperature inside the BD 100 (through a temperature sensor such as a varistor or thermistor), for taking power quality measurements, detecting power outages, measuring the outputs of feedback devices, and others. The embodiment may also include a battery backup for operations in the event of a power loss.

In addition to storing a real-time operating system, the memory of controller 300 of the BD 100 also includes various program code sections such as a software upgrade processing software (which receives, stores, and executes software received via the MV power line), the PLS command processing software (which receives commands from the PLS, and processes the commands, and may return a status back to the PLS), the ADC control software, the power quality monitoring software, the error detection and alarm processing software, the data filtering software, the traffic monitoring software, the network element provisioning software, and a dynamic host configuration protocol (DHCP) Server for auto-provisioning user devices (e.g., user computers) and associated PLMs. As discussed above, operation of these code segments is described in the application incorporated above.

In other embodiments, in addition to the NPI 400, the BD may further include a low voltage interface that includes a modem to be communicatively coupled to the LV power line for transmitting data signals to the user devices coupled to the LV subnet. In one example, the signals are differentially transmitted onto the two LV energized conductors. Thus, user devices in some customer premises may communicate with the BD 100 via a coaxial cable (via a first modem in the BD 100) and user devices in other customer premises may communicate with the BD 100 via their low voltage power lines (via a second modem in the BD, which may be a power line modem chip set). In some embodiments of the system, the system may include a filter device (e.g., low pass filter) at or near the power meter (e.g., of those customers serviced via a coaxial cable) so that in-home power line network communications do not egress onto the LV subnet and interfere with the power line communications between the BD 100 and other customer premises.

Furthermore, if significant bandwidth is needed, communications for user devices in a single home may use both the power line and non-power line medium. For example, high definition television data may be transmitted via the coaxial cable (which may also be connected to the internal coaxial cable network of the home instead of the LV power lines) and Internet traffic may be communicated via the low voltage power lines. Thus, the BD 100 may prioritize and route data traffic to the appropriate access link according to the data type (e.g., voice, Internet radio, video, image, Internet (HTML), and video gaming data), packet size (e.g., giving smaller packets lower or higher priority), and/or transmitting device (e.g., telephone device given higher priority).

In another embodiment, the PLCS may be used by the subscriber as a backup service to a cable Internet service provider (ISP), wireless ISP, or a DSL ISP. Thus, the BD 100 may be coupled to a switch in the customer premises. The switch may be a three port device with one port connected to the user device (e.g., a computer), a second port connected to the alternate ISP system and the third port connected to the PLCS (i.e., the BD 100). If the alternate ISP fails, or becomes slowed (e.g., due to high data traffic), the switch can be actuated to switch user device to be connected to the PLCS. Thus, the user device (e.g., computer), or the PLM, may include software for detecting a failed connection and/or a slowed connection, and for automatically actuating a switch to change to a different broadband provider upon detection. Alternately, the user device may be coupled to both the PLCS and the alternate ISP to increase bandwidth for the user, which may require a router at the customer premises. The alternate ISP may be used for some types of traffic (e.g., voice) and the PLCS may be used for other types of data types (e.g., Internet, HDTV).

In the customer premises, a single PLM may be connected to multiple user devices via a router. The router may be separate or integrated into the same housing as the PLM. The connection from the PLM/router to the user devices may be via an Ethernet connection, twisted pair, coaxial cable, or wireless (e.g., 802.11). Thus, the device may comprise a PLM configured to be plugged into a wall socket to receive and transmit data signals to and from the BD 100 via the PLCC 201 and non-power line medium 150. The PLM may be connected to (or integrated into the same housing as) the router (e.g., via a bus or Ethernet connection). The router may be communicatively coupled to a plurality user devices (such as any of those described herein) via an Ethernet connection. Alternately, the router may be connected to a wireless transceiver (e.g., 802.11 or Bluetooth™) for wireless communications to a plurality of user devices. The Ethernet or wireless transceiver may also be integrated into the same housing as the PLM and router. In still another embodiment, the device may include both an Ethernet transceiver and wireless transceiver (in addition to the router and PLM).

A power usage meter or other utility meter also may be connected to the BD 100 via a coaxial cable that is connected to a connector on the meter collar, thereby providing a separate link to the meter. In addition, if a data filter has been installed on the LV power line, the coaxial cable may be coupled to the LV power line(s) on the customer premises side of the filter via the PLCC to provide a data path around the filter. The coaxial cable may provide a customer premises access link that does not interfere with other customers on the same LV subnet, because the coaxial cable is not connected to the other customer premises while the LV power lines of all the customer premises on the LV subnet are connected.

Finally, the type of data signals communicated may be any suitable type of data signal. The type of signal modulation used can be any suitable signal modulation used in communications (Code Division Multiple Access (CDMA), Time Division Multiple Access (TDMA), Frequency Division Multiplex (FDM), Orthogonal Frequency Division Multiplex (OFDM), and the like). OFDM may be used for one or both of the LV and MV power lines. A modulation scheme producing a wideband signal such as CDMA or OFDM that is relatively flat in the spectral domain may be used to reduce radiated interference to other systems while still delivering high data communication rates. Additionally, as discussed above, the signals may be DOCSIS signals.

In addition, instead of using OFDM signals on the MV power line or LV power line, an alternate embodiment of a PLCS system may use ultra wideband signals or surface wave signals (Goubau waves) to provide communications over the MV and/or LV power lines. In another embodiment, instead of using the MV power lines, the signals, which may be OFDM, UWB, surface waves signals, or another type of signal, may be transmitted on the neutral conductor(s) that span from transformer to transformer. Use of the neutral conductor may reduce the need to isolate from the high voltage of the MV power line and thereby reduce the cost of installation and of the coupler.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A system for providing communications to one or more customer premises having a low voltage power line network, comprising:
a communications device having a first port having a first modem communicatively coupled to a power line, and said communications device having a second port having a second modem in communication with said first modem;
a coaxial cable having a first end and a second end, said first end being coupled to said second port; and
an interface device coupled to said second end of said coaxial cable and to the low voltage power line network, said interface device including a first high pass filter.

2. The system of claim 1, wherein said interface device further comprises a fuse communicatively coupled to said first high pass filter.

3. The system of claim 1, wherein said interface device includes an electrical plug communicatively coupled to said high pass filter and configured to be plugged into an electrical socket.

4. The system of claim 1, wherein said communications device further comprises a router in communication with said first modem and said second modem.

5. The system of claim 4, wherein said communications device further comprises a third port having a third modem communicatively coupled to a low voltage power line.

6. The system of claim 1, wherein said communications device further comprises a third port having a third modem communicatively coupled to a low voltage power line.

7. The system of claim 1, wherein the power line comprises a medium voltage power line.

8. The system of claim 1, wherein the power line comprises a neutral conductor.

9. The system of claim 1, wherein said communications device further comprises:
a controller, and
a computer readable medium encoded with executable instructions to cause said controller to process commands received via the power line.

10. The system of claim 1, wherein said communications device further comprises:
a memory,
a controller in communication with said memory, and
a computer readable medium encoded with executable instructions to cause said controller to store a software program received via the power line in memory and to execute the software program.

11. The system of claim 1, wherein the low voltage power line network includes a first energized conductor, and wherein:
said coaxial cable includes an inner conductor and an outer conductor, and
wherein said first high pass filter communicatively couples said inner conductor to the first energized conductor.

12. The system of claim 11, wherein the low voltage power line network further includes a second energized conductor, and wherein:
said interface device further includes a second high pass filter that communicatively couples said outer conductor to the second energized conductor.

13. The system of claim 11, wherein the low voltage power line network further includes a neutral conductor, and wherein:
said interface device further includes a second high pass filter that communicatively couples said outer conductor to the neutral conductor.

14. A system for providing communications to a customer premises having an internal coaxial cable network, comprising:
a communications device having first port having a first modem communicatively coupled to a medium voltage power line, a second port having a second modem in communication with said first modem, and a router in communication with said first modem and said second modem; and
a coaxial cable having a first end and a second end, said first end coupled to said second port and said second end coupled to the internal coaxial cable network.

15. The system of claim 14, wherein said communications device further comprises a third port having a third modem communicatively coupled to a low voltage power line and said router.

16. The system of claim 14, wherein said communications device further comprises:
a controller, and
a computer readable medium encoded with executable instructions to cause said controller to process commands received via the medium voltage power line.

17. The system of claim 14, wherein said communications device further comprises:
a memory,
a controller in communication with said memory, and
a computer readable medium encoded with executable instructions to cause said controller to store a software program received via the medium voltage power line in memory and to execute the software program.

18. A method of providing communications to a user device disposed at a customer premises having an low voltage power line network, comprising:
receiving first data from a power line;
transmitting a signal representing the first data over a coaxial cable;
coupling the signal from the coaxial cable to the low voltage power line network of the customer premises;
conducting the signal over a portion of the low voltage power line network;
receiving the signal from the low voltage power line network; and
demodulating the signal.

19. The method of claim 18, wherein receiving the first data comprises:
coupling a data signal from the power line; and
demodulating the data signal to provide the first data.

20. The method of claim 19, further comprising, prior to transmitting, routing the first data.

21. The method of claim 18, further comprising:
transmitting a second signal representing second data via the low voltage power line network;
coupling the second signal from the low voltage power line network of the customer premises to the second end of the coaxial cable;
receiving the second signal from the first end of the coaxial cable; and
transmitting the second data via the medium voltage power line.

22. The method of claim 21, wherein receiving the second signal comprises:
demodulating the second signal; and
routing the second data.

23. The method of claim 18, wherein said coupling includes conducting the signal through a high pass filter.

24. The method of claim 23, wherein said coupling further comprises conducting the signal through a fuse.

25. The method of claim 18, further comprising:
receiving a software program via the power line;
storing the software program in memory; and
executing the software program.
